(19) United States
(12) Patent Application Publication
(10) Pub. No.: US 2014/0201923 A1
(43) Pub. Date: Jul. 24, 2014

(54) Bed Scroll

(71) Applicant: William Richard CORDERO, Diamond Bar, CA (US)

(72) Inventor: William Richard CORDERO, Diamond Bar, CA (US)

(21) Appl. No.: 14/160,229

(22) Filed: Jan. 21, 2014

Related U.S. Application Data
(60) Provisional application No. 61/754,726, filed on Jan. 21, 2013.

(51) Int. Cl. A47G 9/06; A61G 99/00

(52) U.S. Cl. CPC A47G 9/06; A61G 99/00
USPC 5/694; 5/690; 5/731

(57) ABSTRACT

A bed scroll is a bedding mat that is able to coil inwards from its left side and its right side. The bed scroll has a first coiling portion and a second coiling portion, which are integrated into the bed scroll and are positioned opposite each other across the bed scroll. The bed scroll is designed to be thermally insulative, organically-impermeable, waterproof, and hypoallergenic. The bed scroll can also be embedded with a topical medication that treats a user's ailments and can have a plurality of massaging protrusions that stimulate the user's skin to prevent pressure ulcers.

The current application claims a priority to the U.S. Provisional Patent application Ser. No. 61/754,726 filed on Jan. 21, 2013.

### FIELD OF THE INVENTION

The present invention relates generally to bedding. More specifically, the present invention is a deployable personal containment system for the purpose of isolating a user from the exterior environment.

### BACKGROUND OF THE INVENTION

A common problem faced by rapid response personnel when attending to medical users is the lack of a rapidly deployable bedding system. These bedding systems must be capable of maintaining user hygiene, a requirement that is difficult to satisfy in many emergency situations such as those involving natural disaster or war zones. The lack of acceptable hygiene often results in victim conditions worsening due to factors such as septic shock from infection. The situation is exacerbated in situations involving a sudden large number of victims requiring medical attention as response personnel and supplies are quickly overwhelmed. Due to the lack of space, victims are often placed onto unsanitary surfaces. The present invention has additional applications beyond the medical applications previously discussed. The present invention is capable of providing users with shelter from the elements as well by providing a containing, impenetrable personal enclosure. The present invention seeks to address the previously discussed issues and provide a rapidly deployable hygienic bedding system for users.

The present invention is a deployable personal containment system for isolating users from an external environment. In the preferred embodiment of the present invention, the personal containment system generally encompasses bedding that is deployable on any surface and that is capable of maintaining a user's hygiene. The personal containment system is nonabsorbent and waterproof in order to completely isolate the user from the exterior surface on which he or she is resting. The personal containment system comprises at least two layers, one of which is composed of a material that causes the bedding to curl around the sides of a user's body, forming a personal enclosure. The material of the present invention is antimicrobial to maintain an acceptable level of hygiene for users. In addition to providing protection from the exterior surface, the material of the present invention is thermal to assist in conserving the body heat of a user. In various embodiments of the present invention, the bedding may be utilized as a delivery system for external medication. The multiple layers forming the personal enclosure system may house medicated membranes containing medication in liquid, powder, or other forms for direct transmission to the user's body. The delivery of medication may be triggered by the pressure exerted by a user's body on the surface of the bedding system.

The present invention seeks to provide a means of isolating a user from a harmful external environment by placing the user into a personal enclosure. The scroll-like material of the present invention allows the personal containment system to envelop a user's body, isolating him or her from the exterior environment. Envelopment of a user's body may be complete, allowing the personal containment system to fully seal the user from the external environment. Additionally, the antimicrobial material and ability to utilize the personal containment system as a medical delivery system minimize the transmission and spread of harmful pathogens such as bacteria and viruses. The present invention also seeks to provide these functions while maintaining a low profile and a high level of portability. Pursuant to this requirement, the present invention may be folded or rolled for convenient storage when not in use.

### BRIEF DESCRIPTION OF THE DRAWINGS

FIG. 1 is an isometric view of the present invention in an unrolled configuration.

FIG. 2 is a front view of the present invention in an unrolled configuration.

FIG. 3 is an isometric view of the present invention in a partially rolled configuration.

FIG. 4 is a front view of the present invention in a partially rolled configuration.

FIG. 5 is an isometric view of the present invention in a fully rolled configuration.

FIG. 6 is a front view of the present invention in a fully rolled configuration.

FIG. 7 is an isometric view of the unrolled present invention in use.

FIG. 8 is an isometric view of the present invention in a fully sealed configuration.

FIG. 9 is a schematic view of an embodiment of the present invention showing the massaging protrusions and the topical medication.

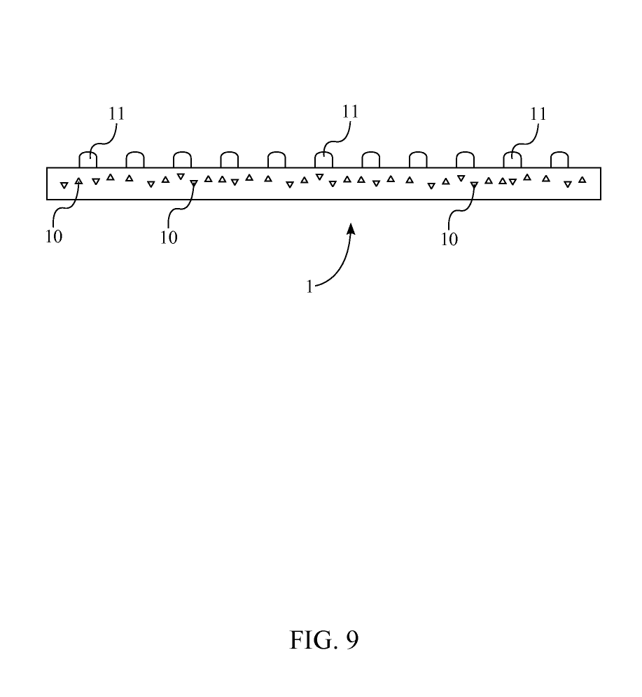

### DETAILED DESCRIPTIONS OF THE INVENTION

All illustrations of the drawings are for the purpose of describing selected versions of the present invention and are not intended to limit the scope of the present invention.

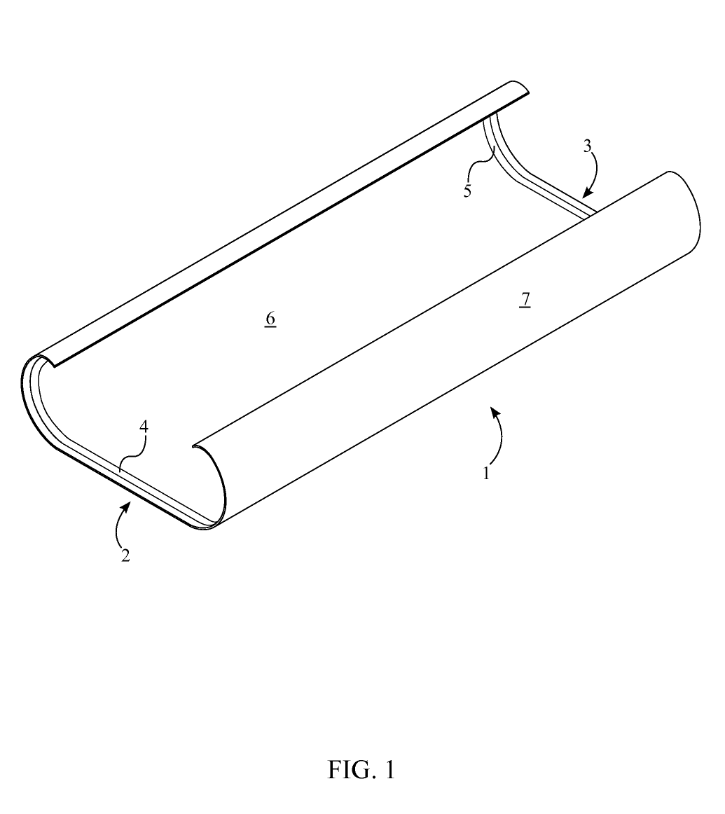

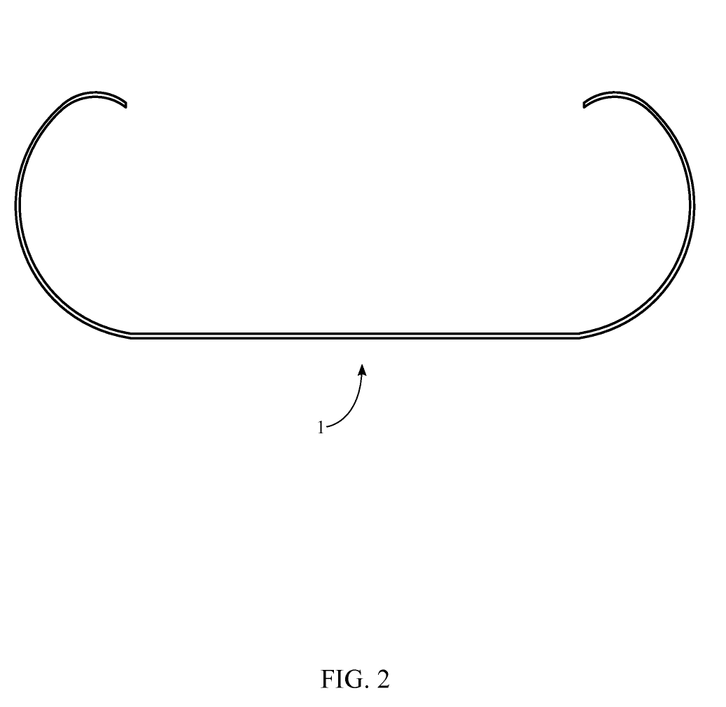

The present invention is a bell scroll that acts a personal containment system and is deployable in all environments for the purpose of isolating the user from the external environment. In its preferred embodiment, the present invention comprises at least two layers of material that form bedding 1 for users. The layers of material are not limited with respect to shape. The materials forming the personal containment system are durable and resilient while remaining comfortable. Of the multiple layers that form the bedding 1, one layer is composed of a material that causes the bedding 1 to curl around the edges of a user's body, forming a scroll-like personal enclosure for the user. This unrolled configuration featuring a personal enclosure is shown in FIG. 1 and FIG. 2. In the preferred embodiment of the present invention, a first curling portion 4 and a second curling portion 5 are integrated into the bedding opposite to each other. Also the preferred embodiment, the bedding comprises a resting surface 6 and a base surface 7, which are positioned opposite to each other through the thickness of the bedding 1. The present invention is laid down on its base surface 7, and the user lays down on the resting surface 6. The bedding 1 is not limited with respect to size in order to accommodate a widely diverse range of users. Furthermore, the material of the personal containment system is hypoallergenic to further increase functionality of the present invention. In the preferred embodiment of the present invention, the bedding 1 of the personal containment system does not require washing. A small section of the bedding 1 on both ends of the bedding 1 is designated for the attachment of various accessories such as pillowcases, and these sections are known as a first accessory attachment section 8 and a second accessory attachment section 9, which are positioned adjacent to their respective sides.

In addition to durability, resiliency, and comfort, the individual layers forming the personal containment system display several additional material properties. The material of the present invention is thermal to assist in conserving the body heat of a user. The material is nonabsorbent, waterproof, and provides an impenetrable barrier between a user's body and the surface on which he or she is resting. This provides a user's body with a personal enclosure that isolates the user from a potentially unsanitary and harmful external environment. As space restrictions are often an issue in rapid response situations, the ability to quickly deploy the personal containment system in virtually any environment is particularly beneficial. Users in rapid response situations such as those in disaster or war zones often require urgent medical care to treat wounds and injuries already suffered. Pursuant to this need, the material of the present invention is antimicrobial to provide users with a sanitary bedding environment during treatment and/or recovery. The sanitary and waterproof properties of the present invention ensure that the personal containment system does not require washing, even after incontinence.

To further satisfy the need for urgent medical treatment in rapid response situations, the present invention may be utilized as a delivery system for external medication 10. This is particularly effective in the management of the transmission and spread of harmful pathogens such as bacteria and viruses. External medication 10 may be pre-applied within the personal containment system or applied after a user is resting within the personal containment system. In an example embodiment of the present invention, a plurality of medicated membranes is embedded within the layers of the personal containment system. The membranes encapsulate liquid medication and/or antibiotics for external use. The membranes are deployed based on pressure applied by a user's body. The pressure experienced by a user's body lying on the personal containment system causes a membrane to burst and direct the internal medication towards the exterior surface and the user's body. In this example embodiment of the present invention, a plurality of medicated membranes is interspersed along the interior layers of the bedding 1 in order to sufficiently treat all areas of the user's body as necessary. Alternatively, a sheet of material featuring embedded medicated membranes may be wrapped around a user's body prior to the user resting upon the personal containment system. As in the previous example, the medicated membranes are activated by the pressure applied by the user's body.

A common dangerous condition faced by bedridden patients is the onset of pressure ulcers, otherwise known as bed sores. Affected skin and tissue becomes damaged and eventually dies in the absence of proper treatment. Pressure ulcers are caused by restricted blood flow in skin and tissue between bone and a surface such as a bed. The condition is worsened when skin is moist and when open wounds become infected due to the transmission and spread of pathogens such as bacteria and viruses. In order to address the potential issue of pressure ulcers in bedridden users, various embodiments of the present invention may feature textured massaging surfaces 11 in direct physical contact with a person's body. The textured massaging surface 11 is capable of improving blood circulation in a patient's body, an important step in preventing pressure ulcers. Additional embodiments of the present invention may feature textures that provide sufficient elevation of the user's body such that air flow and circulation along the user's body is improved.

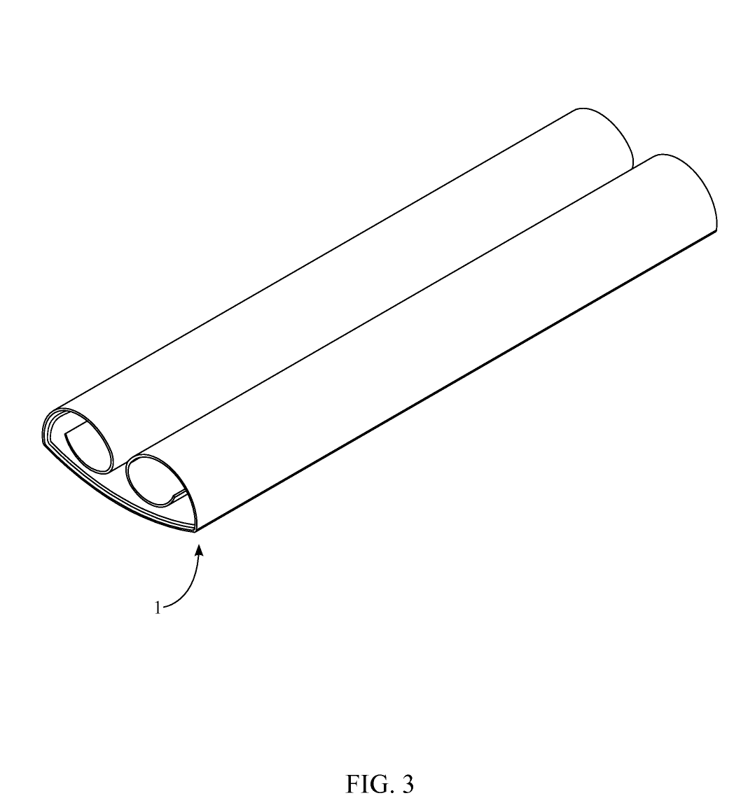

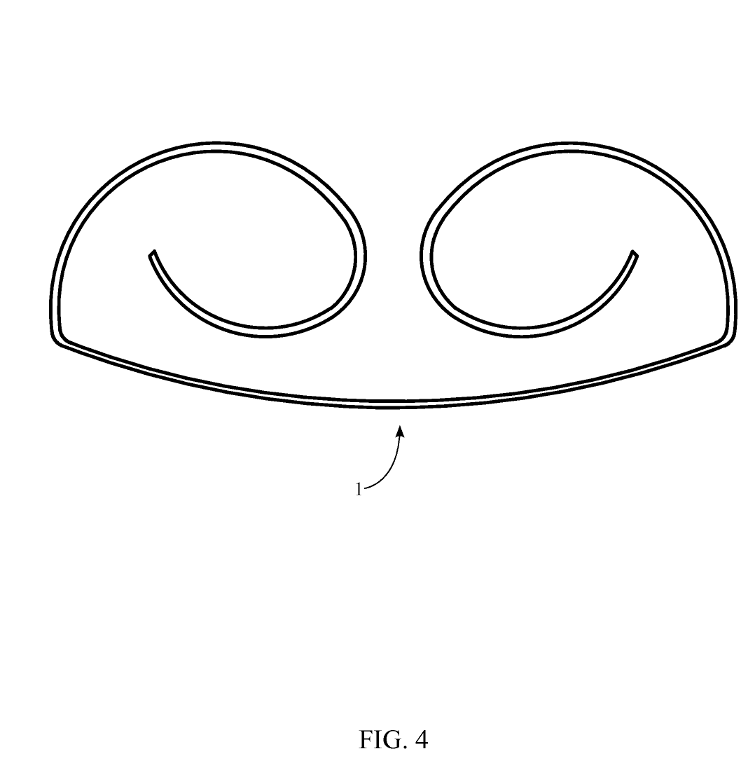

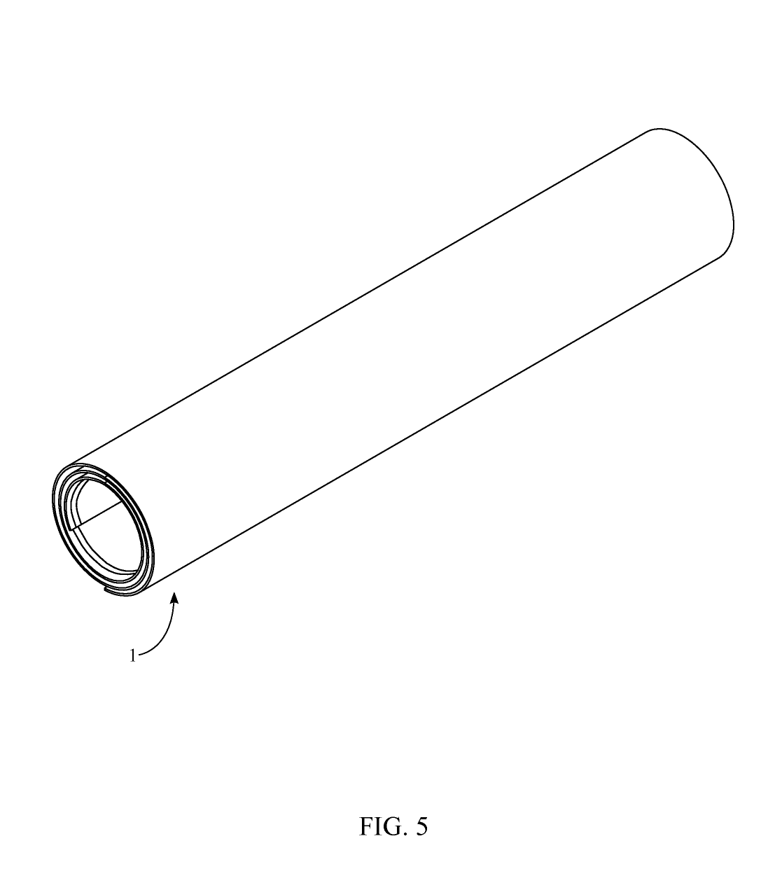

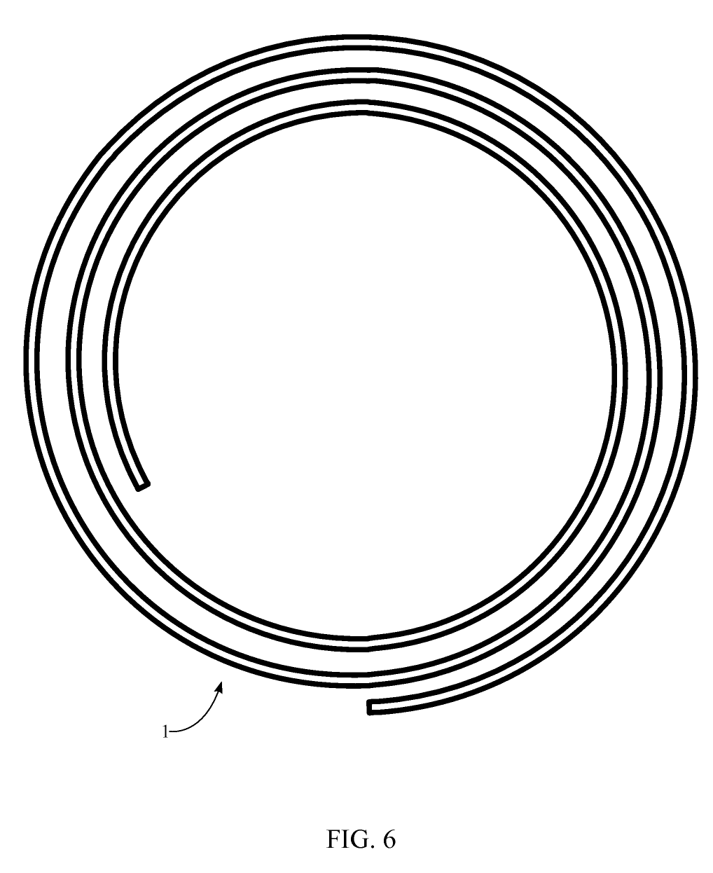

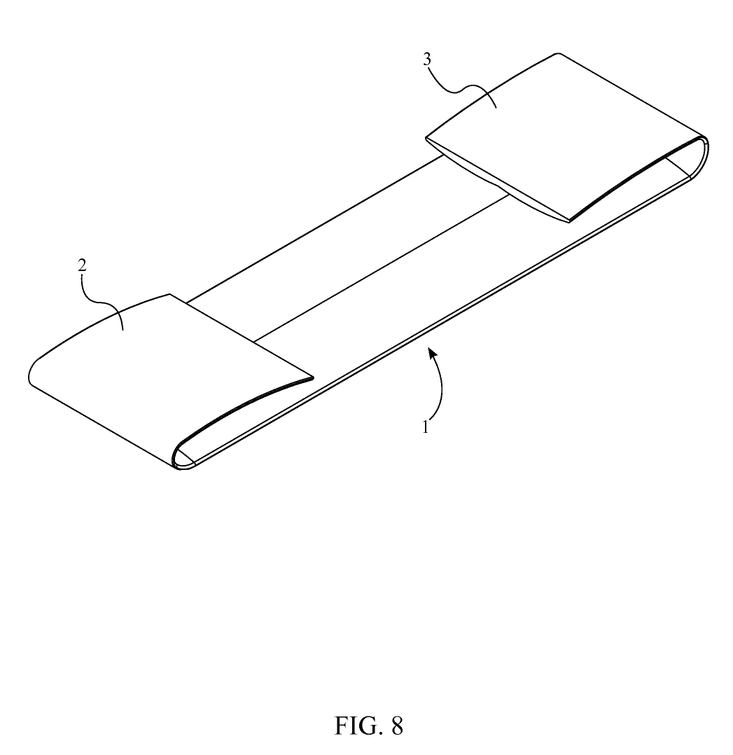

It is an object of the present invention to provide a means of isolating users from a potentially harmful exterior environment by providing each user with an individual enclosure that is easily and quickly deployed. The present invention is a superior alternative to traditional bedding and containment systems for users such as cloth sheets and sleeping bags. These traditional methods of containing users are generally porous, absorbent, and fail to maintain an acceptable level of hygiene, particularly for victims who are bedridden for extended periods of time. The personal containment system of the present invention may be fully sealed from the exterior environment as well as shown in FIG. 8. In the preferred embodiment of the present invention, a first foldable end 2 and a second foldable end 3 are bent inwards in order to create a complete seal of the present invention. A completely sealed personal enclosure forms an impenetrable barrier that shelters a user within the enclosure from the elements. It is a further object of the present invention to maintain a low profile and a high level of portability. Pursuant to this requirement, the present invention is capable of easy storage as the personal containment system may be folded or rolled. As shown in FIG. 3 and FIG. 4, the curling layer of the present invention causes the bedding 1 to behave in a scroll-like manner, curling inwards at the edges. The present invention may also be completely rolled for convenient storage as shown in FIG. 5 and FIG. 6.

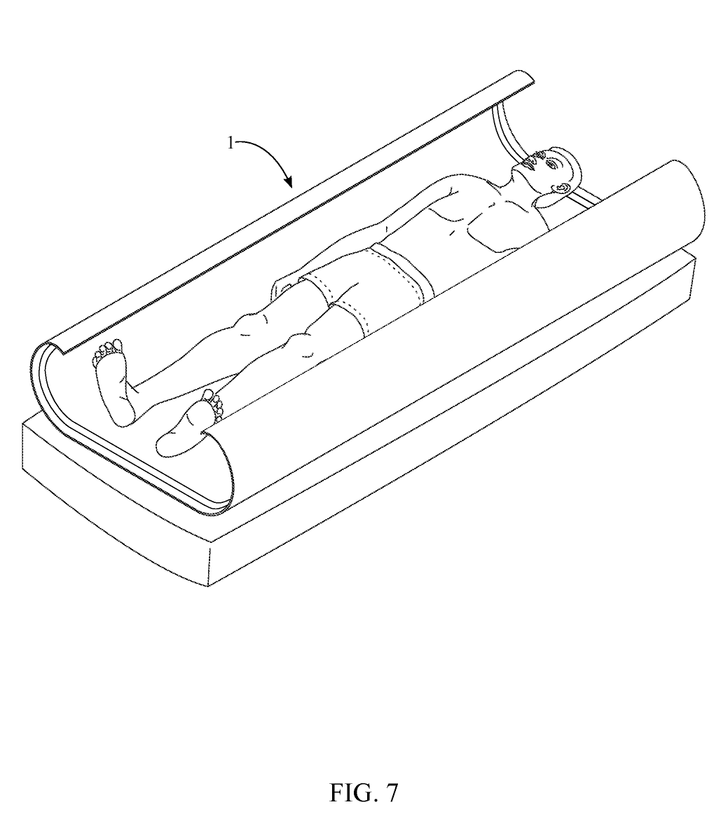

The personal containment system of the present invention is quickly and conveniently deployable on a wide variety of surfaces. Additionally, the present invention does not require any specific training to deploy. Because of this, the present invention is a practical and effective personal containment system for users where traditional bedding is unavailable. In the absence of traditional bedding, rapid response personnel are forced to improvise and efficiently utilize available user space. This means that users are often treated in less than medically ideal situations and environments. In rapid response situations such as those involving disaster or war zones, a primary concern amongst emergency personnel is the transmission and spread of harmful pathogens such as bacteria and viruses. The present invention is capable of providing a personal enclosure for users. The scroll-like material of the personal containment system envelops users while the waterproof and nonabsorbent material properties form an impenetrable barrier. Furthermore, the antimicrobial properties of the material as well as the ability to utilize the containment system as a medical delivery system greatly reduce the chances of pathogenic transmission and spread. The scroll-like behavior of the person containment system facilitates insertion of a user into the personal containment system as the material may be quickly and conveniently opened prior to insertion of the patient. Additionally, in the absence of a user within the containment system, the present invention returns to a default scroll-like configuration as shown in FIG. 3 and FIG. 4. The present invention provides these functions while remaining portable and quickly deployable due to the personal containment system's scroll-like properties and the ability to fold the bedding when not in use. It is noted that the present invention may be utilized on surfaces on traditional bedding such as mattresses as shown in FIG. 7.

In addition to serving as a user personal containment system, the present invention may be utilized as a litter or sleigh during user transport. The user remains within his or her personal enclosure while being transported.

A further additional application of the present invention is a containment system for the deceased. The present invention is a superior alternative to traditional apparatuses such as body bags as the present invention may be fully sealed. Traditional porous body bags do not provide sufficient isolation of corpses from the exterior environment. The containment system of the present invention features a seamless design that provides full isolation of the interior contents from the exterior environment. However, the present invention is not limited solely to the applications previously discussed and may be utilized for various alternative applications as well.

Although the invention has been explained in relation to its preferred embodiment, it is to be understood that many other possible modifications and variations can be made without departing from the spirit and scope of the invention as hereinafter claimed.

What is claimed is:

1. A bed scroll comprises:
a bedding;
said bedding comprises a first foldable end, a second foldable end, a first curling portion, a second curling portion, a resting surface, and a base surface;
said first foldable end and said second foldable end being positioned opposite to each other along a longitudinal axis of said bedding;
said resting surface and said base surface being positioned opposite to each other through a thickness of said bedding;
said first curling portion being integrated into said bedding adjacent to said first foldable end;
said second curling portion being integrated into said bedding adjacent said second foldable end;
said first curling portion and said second curling portion being positioned parallel to each other and positioned perpendicular to said longitudinal axis; and
said first curling portion and said second curling portion being configured to coil said resting surface onto itself.

2. The bed scroll as claimed in claim 1 comprises:
said bedding further comprises a first accessory attachment section and a second accessory attachment section;
said first accessory attachment section and said second accessory attachment section being positioned onto the resting surface;
said first accessory attachment section being positioned adjacent to said first foldable end; and
said second accessory attachment section being position adjacent to the second foldable end.

3. The bed scroll as claimed in claim 1 comprises:
a quantity of topical medication; and
said quantity of topical medication being embedded within said resting surface.

4. The bed scroll as claimed in claim 1 comprises:
a plurality of massaging protrusions;
said plurality of massaging protrusions being connected normal onto said resting surface; and
said plurality of massaging protrusions being uniformly distributed across said resting surface.
